(19) United States
(12) Patent Application Publication
(10) Pub. No.: US 2025/0045412 A1
(43) Pub. Date: Feb. 6, 2025

(54) SBOM MANAGEMENT SYSTEM

(71) Applicant: HITACHI, Ltd., Tokyo (JP)

(72) Inventors: Nobutaka KAWAGUCHI, Santa Clara, CA (US); Charles HART, Watertown, MA (US)

(21) Appl. No.: 18/230,378

(22) Filed: Aug. 4, 2023

(51) Int. Cl. G06F 21/57

(52) U.S. Cl. CPC G06F 21/577; G06F 2221/034

(57) ABSTRACT

Systems and methods described herein involve downloading the container associated with a container download request from a machine, the container being downloaded at a location outside of the machine; executing a running condition of the container for a period of time; monitoring components of the container that are executed or read during the execution of the running condition; estimating packages of the monitored components; generating an active Software Bill of Materials (SBOM) and a potential SBOM from the execution, the active SBOM associated with ones of the packages associated with ones of the monitored components that were read or executed during the execution of the running condition, the potential SBOM being remaining ones of the packages; and transmitting the active SBOM and the potential SBOM to a management server.

### BACKGROUND

### Field

The present disclosure is generally directed to SBOM (Software Bill of Materials) technology, and more specifically, for SBOM management systems.

### Related Art

FIG. 1 illustrates an example of the SBOM architecture. SBOM (Software Bill of Materials) is a machine-readable list of software packages and components. SBOM can be used for fine-grained vulnerability management and communication between suppliers and consumers. Several formats of SBOM are available (e.g., SPDX, Cyclone DX, and so on). As virtualization technologies are prevalent, it is important to manage SBOMs of virtual containers (e.g., docker). Ideally, suppliers should maintain and provide SBOMs. Since the suppliers do not necessarily support SBOMs, however, consumers still need to manage SBOMs of software by themselves. Generally, a container is built by piling up a lot of software. Thus, even if a component is listed in the SBOM, it may be kept dormant while the software is running. From the viewpoint of risk analysis, security operators should grasp whether a component in software is employed or stay dormant during the operation.

In a related art implementation, there is a technique to monitor execution and read of files in a machine, correlate them to SBOM, and then identify relevant vulnerabilities.

### SUMMARY

Related art implementations require an agent program running in a machine. It may be not feasible for machines in production systems. Thus, it is desirable for containers to go through pre-checks before being installed in machines. Even if a machine can install the agent, it is still desirable that vulnerable components at high-risk are never activated at the machine in the first place.

Related art implementations assume the agent already obtains perfect SBOM. When generating SBOMs of containers, Open Source Software (OSS) tools access package managers in the container to extract installed components and the packages. In practice, however, some packages are installed without managers, which makes it difficult for the tools to track unmanaged packages.

Further, even when using agents in machines, the monitoring logs could be quite large, which imposes potentially unmanageable overhead on the management system and network. Thus, the components to be monitored should be controlled by the management system.

Aspects of the present disclosure can involve a method, which can include downloading the container associated with a container download request from a machine, the container being downloaded at a location outside of the machine; executing a running condition of the container for a period of time; monitoring components of the container that are executed or read during the execution of the running condition; estimating packages of the monitored components; generating an active Software Bill of Materials (SBOM) and a potential SBOM from the execution, the active SBOM associated with ones of the packages associated with ones of the monitored components that were read or executed during the execution of the running condition, the potential SBOM being remaining ones of the packages; and transmitting the active SBOM and the potential SBOM to a management server.

Aspects of the present disclosure can involve a computer program, which can include computer instructions involving downloading the container associated with a container download request from a machine, the container being downloaded at a location outside of the machine; executing a running condition of the container for a period of time; monitoring components of the container that are executed or read during the execution of the running condition; estimating packages of the monitored components; generating an active Software Bill of Materials (SBOM) and a potential SBOM from the execution, the active SBOM associated with ones of the packages associated with ones of the monitored components that were read or executed during the execution of the running condition, the potential SBOM being remaining ones of the packages; and transmitting the active SBOM and the potential SBOM to a management server. The computer program and instructions can be stored on a non-transitory computer readable medium and executed by one or more processors.

Aspects of the present disclosure can involve a system, which can include means for downloading the container associated with a container download request from a machine, the container being downloaded at a location outside of the machine; means for executing a running condition of the container for a period of time; means for monitoring components of the container that are executed or read during the execution of the running condition; means for estimating packages of the monitored components; means for generating an active Software Bill of Materials (SBOM) and a potential SBOM from the execution, the active SBOM associated with ones of the packages associated with ones of the monitored components that were read or executed during the execution of the running condition, the potential SBOM being remaining ones of the packages; and means for transmitting the active SBOM and the potential SBOM to a management server.

Aspects of the present disclosure can involve an apparatus, which can include a processor, configured to download the container associated with a container download request from a machine, the container being downloaded at a location outside of the machine; executing a running condition of the container for a period of time; monitor components of the container that are executed or read during the execution of the running condition; estimate packages of the monitored components; generate an active Software Bill of Materials (SBOM) and a potential SBOM from the execution, the active SBOM associated with ones of the packages associated with ones of the monitored components that were read or executed during the execution of the running condition, the potential SBOM being remaining ones of the packages; and transmit the active SBOM and the potential SBOM to a management server.

### BRIEF DESCRIPTION OF DRAWINGS

FIG. 1 illustrates an example of the SBOM architecture.

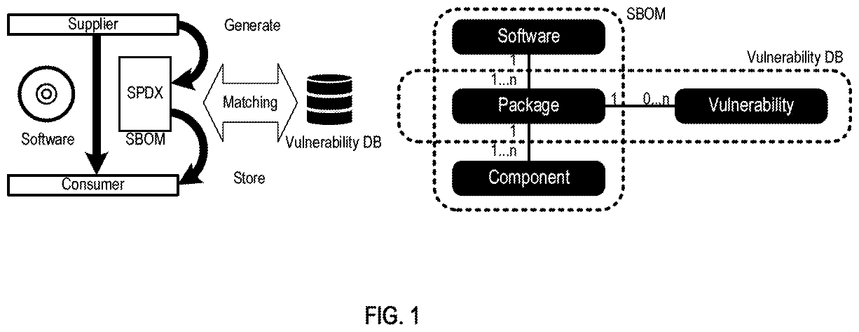

FIG. 2 illustrates an example SBOM management system, in accordance with an example implementation.

FIG. 3 illustrates the flow for the container executor, in accordance with an example implementation.

FIG. 4 illustrates the example flow for the overview of the SBOM Generator, in accordance with an example implementation.

FIG. 5 illustrates an example flow for the package determination portion of the SBOM Generator, in accordance with an example implementation.

FIG. 6 illustrates an example of the flow for the access controller, in accordance with an example implementation.

FIG. 7 illustrates an example flow for the usage monitor, in accordance with an example implementation.

FIG. 8 illustrates an example computing environment with an example computer device suitable for use in some example implementations.

### DETAILED DESCRIPTION OF THE INVENTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means or can be implemented through a desired algorithm. Example implementations as described herein can be utilized either singularly or in combination and the functionality of the example implementations can be implemented through any means according to the desired implementations.

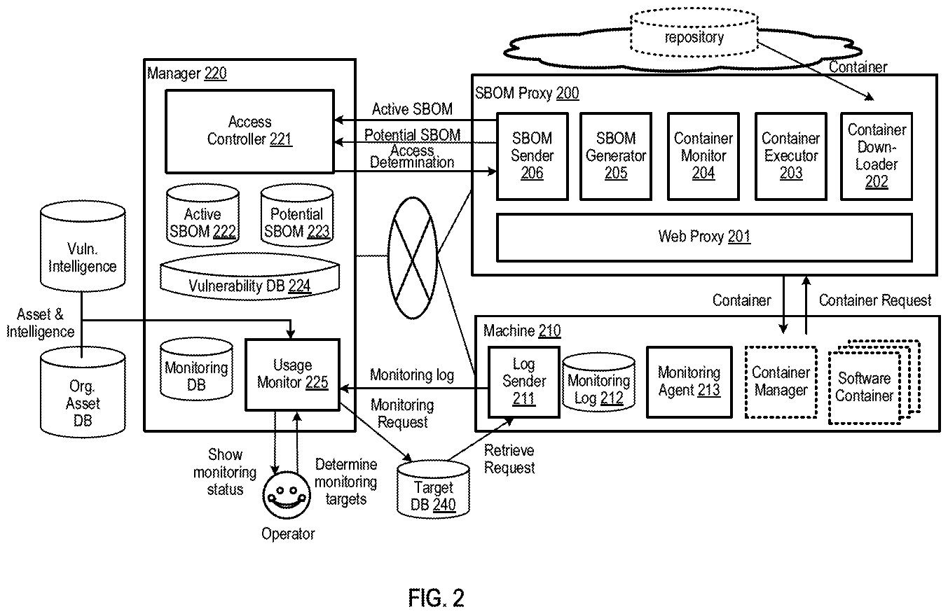

FIG. 2 illustrates an example SBOM management system, in accordance with an example implementation. Example implementations described herein can involve an SBOM proxy 200, that intercepts the container download request from machines and downloads the container, runs the container, generates two types of SBOMs (Active SBOM and Potential SBOM), and sends the SBOMs to the manager 220. Based on the response, the manager 220 allows/denies the download.

Specifically, the SBOM proxy 200 can involve a web proxy 201 that intercepts the container download request from machines 210. Container downloader 202 downloads the container for analysis. Container executor 203 checks the running condition of the container and executes it for a certain period of time (test run). Container Monitor 204 monitors components that are executed or read during the operation. SBOM Generator 205 accesses the package managers of the container and estimates the packages of the monitored components. SBOM sender 206 sends two types of components to the manager 220.

Active SBOM 222 is a list of packages of components that are read or executed during the test execution. The container is considered to be exposed at a relatively high-risk if any of its components listed in Active SBOM is vulnerable. Potential SBOM 223 includes packages that are installed in the container but not listed in active SBOMs. The risk from a vulnerable component that is listed only in the Potential SBOM is considered to be relatively low, while unignorable. Based on the access determination from access controller 221, the web proxy 201 allows/denies the download.

Example implementations described herein can also involve an access controller 221, which receives the Active SBOM 222 and Potential SBOM 223, and by matching the SBOMs with vulnerability database (DB) 224, determines the risk of the container. If the risk is below a threshold, the download is allowed. The SBOMs are then saved to the databases.

Example implementations described herein involve a usage monitor 225, which shows the operators the current SBOMs, vulnerability DBs and monitoring condition. Based on the direction from the operators, the usage monitor 225 determines which components/packages should be monitored. The direct log senders 211 then monitor determined components/packages via target DB 240. The usage monitor 225 receives monitoring logs 212 from log senders 211 and shows them to operators.

Example implementations involve a monitoring agent 213 that monitors executed/read components by containers and software, and registers the usage log of the components and the associated packages to the monitoring log files.

Example implementations involve a log sender 211, which, according to the direction from the usage monitor 225, retrieves logs from the monitoring log files 212 and sends them.

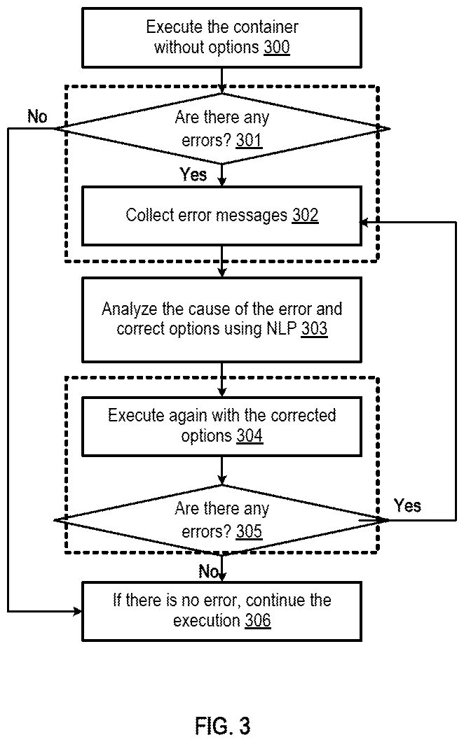

FIG. 3 illustrates the flow for the container executor 203, in accordance with an example implementation. At 300, the flow executes the container without any options. This is because there may not be any information regarding which options are required to execute the container. At 301, a determination is made as to whether there are any errors. If the execution fails due to the option errors (Yes), the flow collects the error messages at 302, otherwise (No), the flow proceeds to 306.

At 303, the flow analyzes the cause of the error using NLP (natural language processing) and then crafts dummy options based on the analysis results. At 304, the flow then re-executes the container with the options. If execution fails again, (Yes), then the flow proceeds back to 302, otherwise (No), the flow proceeds to 306.

At 306, if an error does not appear, it continues the execution until either new components have not been monitored for a certain time period (e.g., within a threshold) or the execution period reaches a timeout threshold.

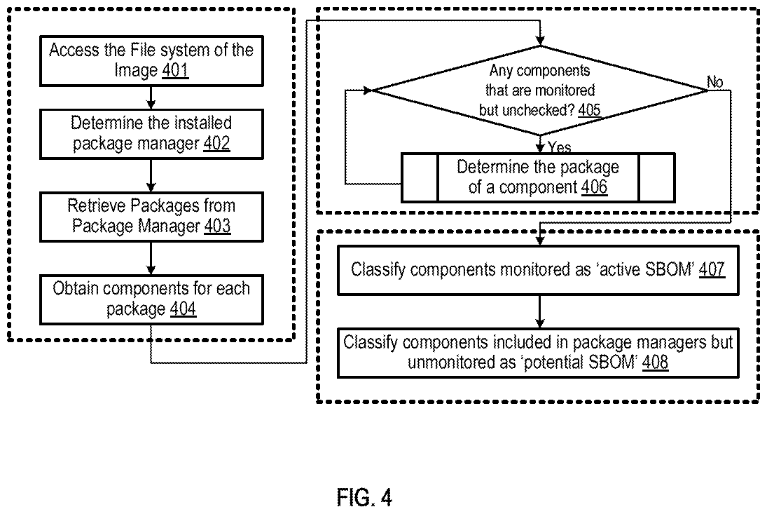

FIG. 4 illustrates the example flow for the overview portion of the SBOM Generator 205, in accordance with an example implementation. At first, the SBOM Generator 205 accesses the container and retrieves components/packages information from package managers (e.g., dpkg, apk). To facilitate such functionality, the SBOM Generator 205 executes a flow as follows.

At 401, the flow accesses the file system of the image. At 402, the flow then determines the installed package manager, and then retrieves packages from the package manager at 403. At 404, the flow then obtains components from each package.

Subsequently, the SBOM Generator 205 determines the packages of monitored components (e.g., executed or read). To facilitate such functionality, the SBOM Generator/Overview 205 executes a flow as follows. At 405, a check is made as to whether any components exist that are monitored but unchecked. If not (No) then the flow proceeds to 407 to start the generation of the active SBOMs and the potential SBOMs, otherwise (Yes), the flow proceeds to 406 to determine the package of the component.

Finally, the SBOM Generator 205 generates the active SBOMs and potential SBOMs. To facilitate such functionality, the SBOM Generator/Overview 205 executes a flow as follows. At 407, the flow classifies monitored components as active SBOMs. At 408, the remaining components that are included in package managers but unmonitored are classified as potential SBOM 408.

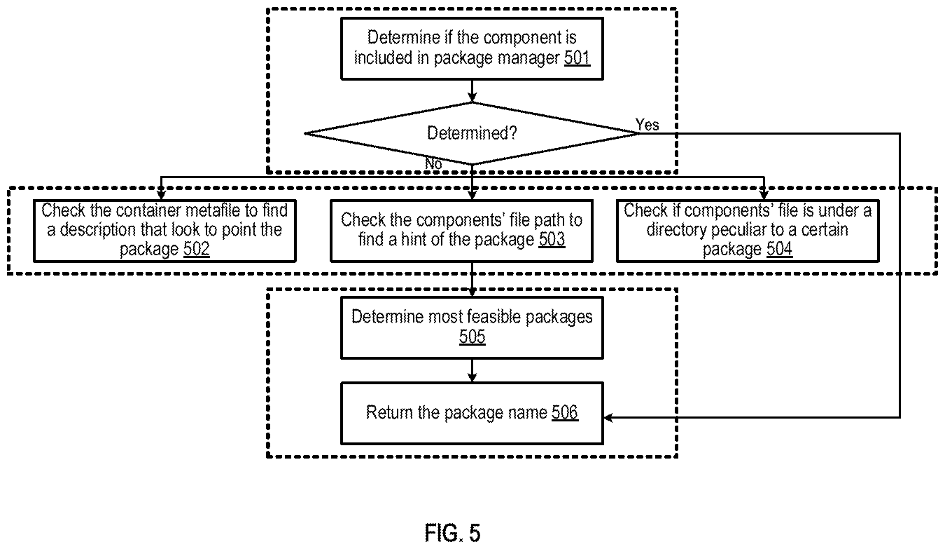

FIG. 5 illustrates an example flow for the package determination portion of the SBOM Generator 205, in accordance with an example implementation. This flow is the execution of the package determination component 406 of FIG. 4. At first, the SBOM Generator 205 checks whether the file path of the component is included in the package manager. If it is determined that the file path of the component is included in the package manager (Yes), then the flow proceeds to return the package name at 506, otherwise (No), the flow proceeds to use heuristic approaches using container metafile, file path and directories. For example, the flow can check the container metafile to find a description that looks like it points at the package at 502. The flow can also check the components' file path to ascertain any hints regarding the location of the package at 503. Additionally, the flow can check if the components' file is under a directory peculiar to a certain package at 504.

At 505, the flow then determines the most feasible package based on the heuristics, and returns the obtained package name at 506.

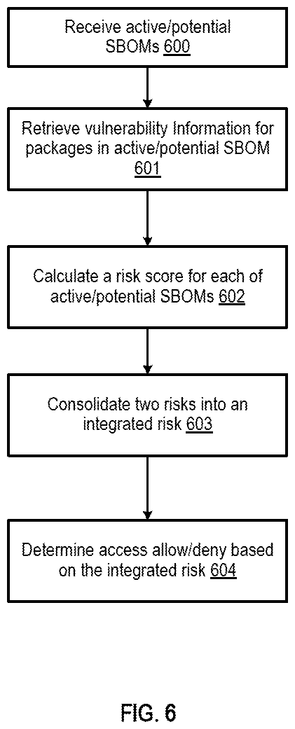

FIG. 6 illustrates an example of the flow for the access controller 221, in accordance with an example implementation.

At 600, the flow receives active/potential SBOMs from the SBOM sender. At 601, the flow retrieves vulnerability information for packages in the active/potential SBOM. Vulnerability information usually contains a vulnerable package and the corresponding risk score. Thus, access controller 221 can list up a set of risk scores for each component of SBOM by matching it with the vulnerability information stored in the access controller 221. If a component is matched with an entry of vulnerability information, it imposes a risk proportional to the corresponding risk score to the container. On the other hand, if a component is not matched with the vulnerability information, it doesn't impose any risk to the container.

At 602, the flow calculates a risk score for each SBOM. The risk score can be a sum of the risks for the matched components or more sophisticated mathematics can be applied, depending on the desired implementation. At 603, the flow consolidates the two risks into an integrated risk. The score can be both a vector composed of the two scores or a scalar, depending on the desired implementation.

At 604, a determination for the access (allow/deny) is executed based on the integrated risk. If the consolidated score gets over a threshold, the access is denied. Otherwise, the access is allowed.

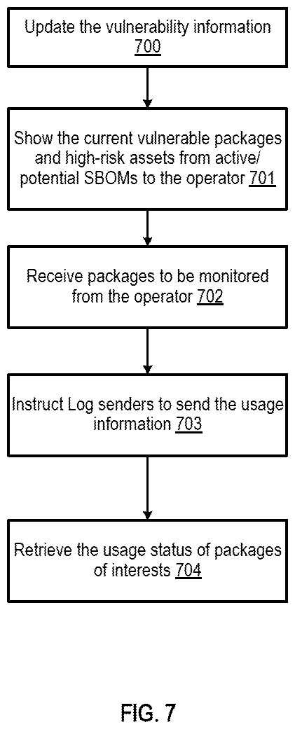

FIG. 7 illustrates an example flow for the usage monitor 225, in accordance with an example implementation. At first, the usage monitor 225 updates the vulnerability information periodically by accessing vulnerability intelligence on the Internet at 700. At 701, the usage monitor 225 matches the information with SBOMs (both active and potential) and identifies vulnerable packages and high-risk assets. High-risk assets are identified by vulnerable packages included in installed container images and the organization's asset DB. The process is important since SBOMs once judged as invulnerable could turn vulnerable if a new vulnerability is found. The current vulnerable packages and high-risk assets from active/potential SBOMs to the operator are then provided.

At 702, the security operator determines which packages should be monitored in each asset, and the usage monitor 225 receives the packages accordingly. The process can be also automated by defining rules in accordance with the desired implementation.

At 703, the usage monitor 225 puts lists of monitoring target packages (monitoring request) in the target DB 240. Log sender 211 periodically accesses the DB and retrieves monitoring targets and starts monitoring.

At 704, the usage monitor 225 receives usage information from Log senders 211 and displays them to the security operator.

Through the example implementations described herein, the system can analyze the risk of installed containers more accurately by generating two types of SBOMs (Active SBOM for packages whose components are actually executed/read during the test run, and Potential SBOM for those included in the container but whose components are not executed/read during the test run).

Further, through the example implementations described herein, the system can identify packages not registered to package managers by executing the container and monitoring the features of executed/read components.

In addition, through the example implementations described herein, the system can monitor the usage of generated SBOMs without imposing high overhead on the network and SBOM manager by limiting monitored packages to those that would concern the security operator.

Further, variations of the above example implementations are also possible to accommodate the desired implementation. For example, it may be beneficial to perform a quick penetration testing at the test run in the SBOM proxy since it could reveal additional packages that are employed only when a particular input is received. In this case, a new function performing penetrating testing can be added to facilitate the desired implementation.

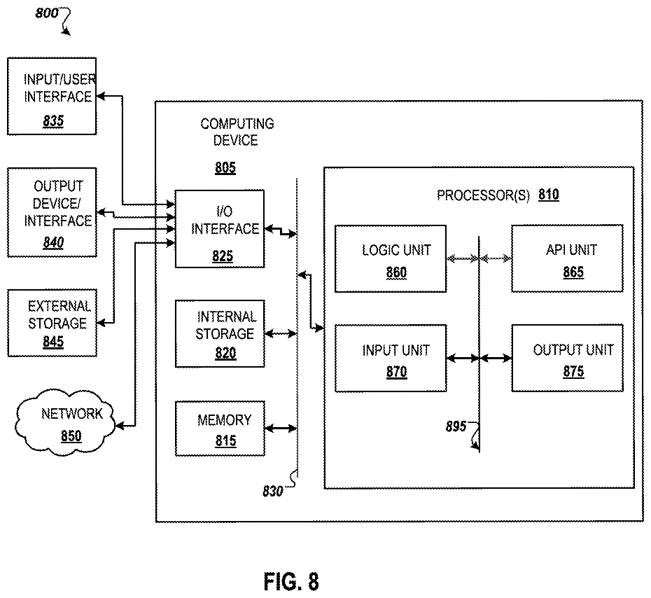

FIG. 8 illustrates an example computing environment with an example computer device suitable for use in some example implementations, such as a management server or management computer configured to execute the functions as described in FIG. 2 for the manager 220 and access controller 221, to function as the SBOM Proxy 200, and/or to function as a machine 210. Computer device 805 in computing environment 800 can include one or more processing units, cores, or processors 810, memory 815 (e.g., RAM, ROM, and/or the like), internal storage 820 (e.g., magnetic, optical, solid-state storage, and/or organic), and/or IO interface 825, any of which can be coupled on a communication mechanism or bus 830 for communicating information or embedded in the computer device 805. IO interface 825 is also configured to receive images from cameras or provide images to projectors or displays, depending on the desired implementation.

Computer device 805 can be communicatively coupled to input/user interface 835 and output device/interface 840. Either one or both of the input/user interface 835 and output device/interface 840 can be a wired or wireless interface and can be detachable. Input/user interface 835 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 840 may include a display, television, monitor, printer, speaker, braille, or the like. In some example implementations, input/user interface 835 and output device/interface 840 can be embedded with or physically coupled to the computer device 805. In other example implementations, other computer devices may function as or provide the functions of input/user interface 835 and output device/interface 840 for a computer device 805.

Examples of computer device 805 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 805 can be communicatively coupled (e.g., via IO interface 825) to external storage 845 and network 850 for communicating with any number of networked components, devices, and systems, including one or more computer devices of the same or different configuration. Computer device 805 or any connected computer device can be functioning as, providing services of, or referred to as a server, client, thin server, general machine, special-purpose machine, or another label.

IO interface 825 can include but is not limited to, wired and/or wireless interfaces using any communication or IO protocols or standards (e.g., Ethernet, 802.11x, Universal System Bus, WiMAX, modem, a cellular network protocol, and the like) for communicating information to and/or from at least all the connected components, devices, and network in computing environment 800. Network 850 can be any network or combination of networks (e.g., the Internet, local area network, wide area network, a telephonic network, a cellular network, satellite network, and the like).

Computer device 805 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 805 can be used to implement techniques, methods, applications, processes, or computer-executable instructions in some example computing environments. Computer-executable instructions can be retrieved from transitory media and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 810 can execute under any operating system (OS) (not shown), in a native or virtual environment. One or more applications can be deployed that include logic unit 860, application programming interface (API) unit 865, input unit 870, output unit 875, and inter-unit communication mechanism 895 for the different units to communicate with each other, with the OS, and with other applications (not shown). The described units and elements can be varied in design, function, configuration, or implementation and are not limited to the descriptions provided. Processor(s) 810 can be in the form of hardware processors such as central processing units (CPUs) or in a combination of hardware and software units.

In some example implementations, when information or an execution instruction is received by API unit 865, it may be communicated to one or more other units (e.g., logic unit 860, input unit 870, output unit 875). In some instances, logic unit 860 may be configured to control the information flow among the units and direct the services provided by API unit 865, the input unit 870, the output unit 875, in some example implementations described above. For example, the flow of one or more processes or implementations may be controlled by logic unit 860 alone or in conjunction with API unit 865. The input unit 870 may be configured to obtain input for the calculations described in the example implementations, and the output unit 875 may be configured to provide an output based on the calculations described in example implementations.

Processor(s) 810 can be configured to execute a method or computer instructions involving downloading a container associated with a container download request from a machine, the container being downloaded at a location outside of the machine (e.g., SBOM proxy 200 via container downloader 202); executing a running condition of the container for a period of time (e.g., via container executor 203); monitoring components of the container that are executed or read during the execution of the running condition (e.g., via container monitor 204); estimating packages of the monitored components (e.g., via SBOM generator 205); generating an active Software Bill of Materials (SBOM) and a potential SBOM from the execution, the active SBOM associated with ones of the packages associated with ones of the monitored components that were read or executed during the execution of the running condition, the potential SBOM being remaining ones of the packages (e.g., via SBOM Generator 205); and transmitting the active SBOM and the potential SBOM to a management server (e.g., via SBOM sender 206).

Processor(s) 810 can be configured to execute the method or computer instructions as described above, and further involve denying or allowing the download of the container to the machine based on an access determination from the management server in response to the active SBOM and the potential SBOM (e.g., via access controller 221 transmitting access determination to SBOM sender 206). In an example implementation, the access determination is can be based on the result of matching between Active SBOM to the vulnerability information from vulnerability database as described with respect to FIG. 6.

Processor(s) 810 can be configured to execute the method or instructions as described above, wherein the estimating the packages of the monitored components involves, for each of the monitored components, determining if a file path of the each of the monitored components is included in a package manager; and for a determination that the file path is included, including packages in the file path in the estimated packages as shown at 501 of FIG. 5.

Processor(s) 810 can be configured to execute the method or instructions as described above, wherein the estimating the packages of the monitored components involves, for the determination that the file path is not included, checking a metafile of the container to obtain a description that points to the packages associated with the each of the monitored components, and including the packages associated with the each of the monitored components found from the description as shown at 502 of FIG. 5.

Processor(s) 810 can be configured to execute the method or instructions as described above, wherein the estimating the packages of the monitored components involves, for the determination that the file path is not included, checking for the packages in a directory of the each of the monitored components, and including the packages found in the directory in the estimated packages as shown at 503 of FIG. 5.

Processor(s) 810 can be configured to execute the method or instructions as described above, wherein the estimating the packages of the monitored components involves, for the determination that the file path is not included, checking a file path of the each of the monitored component to find the packages associated with the each of the monitored component; and including the found packages in the estimated packages as shown at 504 of FIG. 5.

Processor(s) 810 can be configured to execute the method or instructions as described above, and further involve determining the running condition, the determining the running condition involving executing the container without any options (e.g., as shown at 300 in FIG. 3); for the execution of the container without any options having no errors, returning the running condition as executing the container without any options (e.g., as shown at 301 and 306 in FIG. 3); for the execution of the container without any options failing due to errors, generating dummy options for the container based on analysis of the errors; reexecuting the container with the dummy options; reiterating the generating of the dummy options and the reexecution of the container with the dummy options until the container executes with the dummy options without any errors; and returning the dummy options as the running condition of the container as shown at 303 to 306 of FIG. 3.

Processor(s) 810 can be configured to execute the method or instructions as described above, wherein the method is executed in response to an intercept of the container download request from a machine or in response to a request made from the machine 210 as shown by the container request being intercepted by web proxy 201.

Depending on the desired implementation, the management server can be configured to, in response to receiving the active SBOM and the potential SBOM (e.g., via access controller 221 to store active SBOM 222 and potential SBOM 223), retrieve vulnerability information for the packages in the active SBOM and the potential SBOM (e.g., via Vulnerability DB 224); determine risk based on a first risk assessment of vulnerabilities of the active SBOM and a second risk assessment of the potential SBOM; and deny or allow the download of the container to the machine based on the determined risk as illustrated in FIG. 6.

Depending on the desired implementation, the management server can be configured to obtain updated vulnerability information for the packages in the active SBOM and the potential SBOM; select ones of the packages to monitor based on the updated vulnerability information; and read usage status of the monitored packages from logs in a target database for the selected components, the logs in the target database provided by the machine during execution of the container as illustrated in FIG. 7.

Depending on the desired implementation, the machine 210 can conduct the estimating of the packages of the running components. In such an example implementation the monitoring agent 212 can have functionalities similar to the Container Monitor 204 and SBOM Generator 205 to observe read/execution operation on files and identify the corresponding packages.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method, comprising:
downloading a container associated with a container download request from a machine, the container being downloaded at a location outside of the machine;
executing a running condition of the container for a period of time;
monitoring components of the container that are executed or read during the execution of the running condition;
estimating packages of the monitored components;
generating an active Software Bill of Materials (SBOM) and a potential SBOM from the execution, the active SBOM associated with ones of the packages associated with ones of the monitored components that were read or executed during the execution of the running condition, the potential SBOM being remaining ones of the packages; and
transmitting the active SBOM and the potential SBOM to a management server.

2. The method of claim 1, further comprising:
denying or allowing the download of the container to the machine based on an access determination from the management server in response to the active SBOM and the potential SBOM.

3. The method of claim 1, wherein the estimating the packages of the monitored components comprises:
for each of the monitored components, determining if a file path of the each of the monitored components is included in a package manager; and
for a determination that the file path is included, including packages in the file path in the estimated packages.

4. The method of claim 3, wherein the estimating the packages of the monitored components comprises:
for the determination that the file path is not included, checking a metafile of the container to obtain a description that points to the packages associated with the each of the monitored components, and including the packages associated with the each of the monitored components found from the description.

5. The method of claim 3, wherein the estimating the packages of the monitored components comprises:
for the determination that the file path is not included, checking for the packages in a directory of the each of the monitored components, and including the packages found in the directory in the estimated packages.

6. The method of claim 3, wherein the estimating the packages of the monitored components comprises:
for the determination that the file path is not included, checking a file path of the each of the monitored component to find the packages associated with the each of the monitored component; and
including the found packages in the estimated packages.

7. The method of claim 1, further comprising determining the running condition, the determining the running condition comprising:
executing the container without any options;
for the execution of the container without any options having no errors, returning the running condition as executing the container without any options;
for the execution of the container without any options failing due to errors:
generating dummy options for the container based on analysis of the errors;
reexecuting the container with the dummy options;
reiterating the generating of the dummy options and the reexecution of the container with the dummy options until the container executes with the dummy options without any errors; and
returning the dummy options as the running condition of the container.

8. The method of claim 1, wherein the method is executed in response to an intercept of the container download request from the machine or in response to a request made from the machine.

9. The method of claim 1, wherein the management server is configured to in response to receiving the active SBOM and the potential SBOM:
retrieve vulnerability information for the packages in the active SBOM and the potential SBOM;
determine risk based on a first risk assessment of vulnerabilities of the active SBOM and a second risk assessment of the potential SBOM; and
deny or allow the download of the container to the machine based on the determined risk.

10. The method of claim 1, wherein the management server is configured to:
obtain updated vulnerability information for the packages in the active SBOM and the potential SBOM;
select ones of the packages to monitor based on the updated vulnerability information; and
read usage status of the monitored packages from logs in a target database for the selected components, the logs in the target database provided by the machine during execution of the container.

11. The method of claim 1, wherein the machine conducts the estimating of the packages of the running components.

12. A non-transitory computer readable medium, storing instructions for executing a process, the instructions comprising:
downloading a container associated with a container download request from a machine, the container being downloaded at a location outside of the machine;
executing a running condition of the container for a period of time;
monitoring components of the container that are executed or read during the execution of the running condition;
estimating packages of the monitored components;
generating an active Software Bill of Materials (SBOM) and a potential SBOM from the execution, the active SBOM associated with ones of the packages associated with ones of the monitored components that were read or executed during the execution of the running condition, the potential SBOM being remaining ones of the packages; and
transmitting the active SBOM and the potential SBOM to a management server.

13. An apparatus, comprising:
a processor, configured to:
download a container associated with a container download request from a machine, the container being downloaded at a location outside of the machine;
execute a running condition of the container for a period of time;
monitor components of the container that are executed or read during the execution of the running condition;
estimate packages of the monitored components;
generate an active Software Bill of Materials (SBOM) and a potential SBOM from the execution, the active SBOM associated with ones of the packages associated with ones of the monitored components that were read or executed during the execution of the running condition, the potential SBOM being remaining ones of the packages; and
transmit the active SBOM and the potential SBOM to a management server.
